(19) United States
(12) Patent Application Publication
(10) Pub. No.: US 2020/0074278 A1
(43) Pub. Date: Mar. 5, 2020

(54) Farming Portfolio Optimization with Cascaded and Stacked Neural Models Incorporating Probabilistic Knowledge for a Defined Timeframe

(71) Applicant: International Business Machines Corporation, Armonk, NY (US)

(72) Inventors: Sathya Santhar, Ramapuram (IN); Abhay Patra, Pune (IN); Harish Bharti, Pune (IN); Sarbajit K. Rakshit, Kolkata (IN)

(21) Appl. No.: 16/117,558

(22) Filed: Aug. 30, 2018

(51) Int. Cl. G06N 3/04; G06N 3/08; A01B 79/00

(52) U.S. Cl. CPC G06N 3/0445; A01B 79/005; G06N 3/08; G06N 3/0454

(57) ABSTRACT

Optimizing the allocation of farmland between different crops is provided. First and second Deep Boltzmann machines (DBMs) are built, wherein the hidden layers of the DBMs are split into a plurality of neural networks, each neural network modeling a different timeframe of crop growth. A plurality of factors related to crop growth are fed into the first DBM, which is trained to produce a first multi-class output of predicted maximum crop yields within a specified overall timeframe. The first multi-class output is fed into the second DBM, which is trained to produce a second multi-class output of predicted crop yields. The second multi-class output is fed into a decision support system that generates a recommended allocation of the farmland among different crops during different timeframes to maximize total yield.

### BACKGROUND

### 1. Field:

The disclosure relates generally to artificial intelligence and neural networks and more specifically to the application of neural networks to optimize the allocation of agricultural land and resources among different crops within defined space and time constraints.

### 2. Description of the Related Art:

Large scale farming depends on how well farming is planned based on various parameters, available resources, and constraints. Not all crops produce good yields in all seasons of the year as well as in all soils, weather, and environmental conditions. A key problem farmers face across the globe is uncertainty of the environment and weather, which impacts the yield and exposes them to significant risk and negative consequences. Therefore, to effectively manage annual farming portfolios and ensure maximum yield and profit it becomes prudent to efficiently plan farming across various seasons, locations, weather and soil conditions.

The field of Smart Farming utilizes multiple data sources related to farming such as climate and other impacting parameters. These data sources are correlated to provide suggestions to farmers based on collected metadata. Current methods include statistical methods (e.g., weighted averages, extrapolation, etc.), empirical models based on weather data, models based on remote sensing data, normalized difference vegetation index (NDVI), and linear regression models. These methods and models are used for delineating relationships between crop yields and various factors affecting them.

For example, statistical models are often used to predict crop yield in an area. Crop simulations models might describe crop growth every day, and remote sensing data can be used to analyze spatial images. However, these methods only provide static crop analysis such as determining a maximum yield if crop A is planted in area B based on the impacting parameters. They do not provide a comprehensive mechanism to efficiently plan farming across various seasons, locations, weather and soil conditions.

### SUMMARY

According to one illustrative embodiment, a computer-implemented method for optimizing the allocation of farmland between different crops is provided. First and second Deep Boltzmann machines (DBMs) are built, wherein the hidden layers of the DBMs are split into a plurality of neural networks, each neural network modeling a different timeframe of crop growth. A plurality of factors related to crop growth are fed into the first DBM, which is trained to produce a first multi-class output of predicted maximum crop yields within a specified overall timeframe. The first multi-class output is fed into the second DBM, which is trained to produce a second multi-class output of predicted crop yields. The second multi-class output is fed into a decision support system that generates a recommended allocation of the farmland among different crops during different timeframes to maximize total yield.

According to other illustrative embodiments, a computer system and computer program product for optimizing the allocation of farmland between different crops are provided.

### BRIEF DESCRIPTION OF THE DRAWINGS

FIG. 1 is a pictorial representation of a network of data processing systems in which illustrative embodiments can be implemented;

FIG. 2 is a diagram that illustrates a node in a neural network in which illustrative embodiments can be implemented;

FIG. 3 is a diagram illustrating a restricted Boltzmann machine in which illustrative embodiments can be implemented;

FIG. 4 is a diagram illustrating a Deep Boltzmann machine in which illustrative embodiments can be implemented;

FIG. 5 depicts a cascaded Deep Boltzmann machine in which illustrative embodiments can be implemented;

FIG. 6 depicts a second cascaded Deep Boltzmann machine in which illustrative embodiments can be implemented;

FIG. 7 is a flowchart illustrating a process flow of optimizing allocation of agricultural resources in which illustrative embodiments can be implemented;

FIG. 8 is a flowchart illustrating a process flow for training a cascaded Deep Boltzmann machine in which illustrative embodiments can be implemented; and

FIG. 9 is a diagram of a data processing system in which illustrative embodiments may be implemented.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention. It should be appreciated that the Figures are only meant as examples and are not intended to assert or imply any limitation with regard to the environments in which different embodiments may be implemented. Many modifications to the depicted environments may be made.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

The present disclosure provides a method and system for determining a diversified and balanced farming portfolio. It increases the accuracy of prediction for a defined time frame based on a user's constraints on the farming period and proposes a balanced portfolio for that time frame by introducing neural models defines for specific periods of time and stacking them together. Balanced portfolios are obtained by the optimal split of the farm land for planting different crops along with allocation of crops to each section of the farm at different time frames defined by a decision support system.

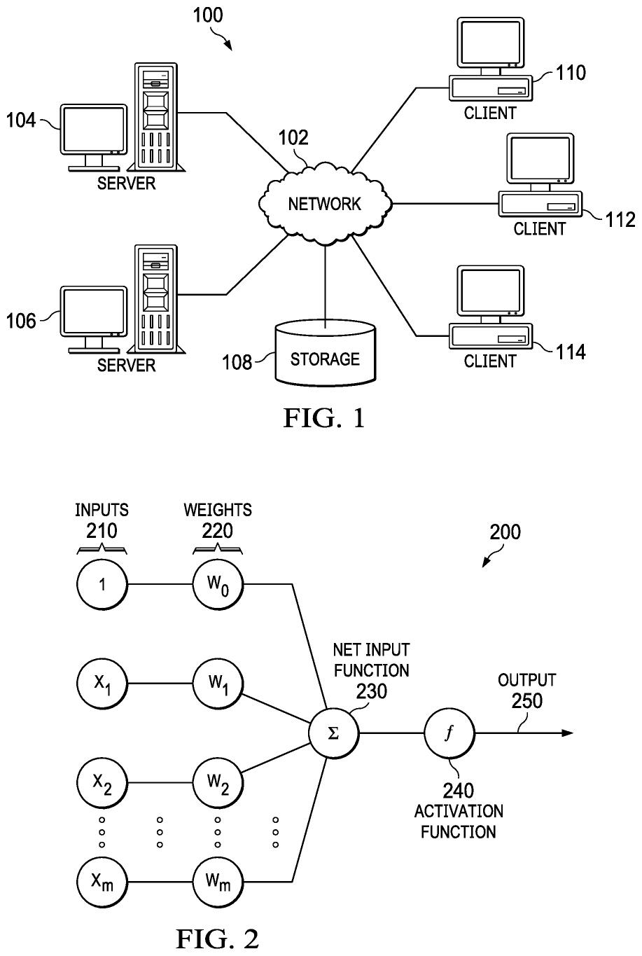

FIG. 1 depicts a pictorial representation of a network of data processing systems in which illustrative embodiments can be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide a set of one or more connector services for managing idempotent operations on a system of record, such as storage 108. An idempotent operation is an identical operation, which was previously performed or executed, that has the same effect as performing a single operation. Also, it should be noted that server 104 and server 106 may each represent a plurality of servers providing management of idempotent operations for a plurality of system of records.

Client 110, client 112, and client 114 also connect to network 102. Clients 110, 112, and 114 are clients of server 104 and server 106. Server 104 and server 106 may provide information, such as boot files, operating system images, and software applications to clients 110, 112, and 114.

In this example, clients 110, 112, and 114 are shown as desktop or personal computers. However, it should be noted that clients 110, 112, and 114 are intended as examples only. In other words, clients 110, 112, and 114 may include other types of data processing systems, such as, for example, network computers, laptop computers, tablet computers, handheld computers, smart phones, smart watches, personal digital assistants, gaming devices, set-top boxes, kiosks, and the like. Users of clients 110, 112, and 114 may utilize clients 110, 112, and 114 to access system of records corresponding to one or more enterprises, via the connector services provided by server 104 and server 106, to perform different data operations. The operations may be, for example, retrieve data, update data, delete data, store data, and the like, on the system of records.

Storage 108 is a network storage device capable of storing any type of data in a structured format or an unstructured format. In addition, storage 108 may represent a plurality of network storage devices. Further, storage 108 may represent a system of record, which is an authoritative data source, corresponding to an enterprise, organization, institution, agency, or similar entity. Furthermore, storage unit 108 may store other types of data, such as authentication or credential data that may include user names, passwords, and biometric data associated with client users and system administrators, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), and a wide area network (WAN). FIG. 1 is intended as an example only, and not as an architectural limitation for the different illustrative embodiments.

Artificial neural networks are computing systems inspired by biological neural networks and are designed to learn to perform tasks by analyzing examples without being programmed with task-specific rules. A neural network comprises a collection of connected nodes or units (artificial “neurons”) that can transmit signals to one another similar to biological neurons. A node or unit is where calculations take place. A node that receives a signal can process it and then signal additional nodes connected to it.

Neural networks recognize patterns by clustering and classifying raw input data. These patterns are numerical, denoted by vectors into which real-world data (e.g., images, text, time series) are translated. During learning, neural networks find correlations by approximating an unknown function f(x)=y between any input x and any output y, assuming x and y are in fact related by correlation or causation. In the learning process, the neural network finds the correct function for transforming x into y.

FIG. 2 is a diagram that illustrates a node in a neural network in which illustrative embodiments can be implemented. Node 200 combines multiple inputs 210 from other nodes . Each input 210 is multiplied by a respective weight 220 that either amplifies or dampens that input, thereby assigning significance to each input for the task the algorithm is trying to learn. The weighted inputs are summed by a net input function 230 and then passed through an activation function 240 to determine the output 250. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

Stochastic neural networks are a type of network that incorporate random variables, which makes them well suited for optimization problems. This is done by giving the nodes in the network stochastic (randomly determined) weights or transfer functions. A Boltzmann machine is a type of stochastic neural network in which each node is binary valued, and the chance of it firing depends on the other nodes in the network. Each node is a locus of computation that processes an input and begins by making stochastic decisions about whether to transmit that input or not. The weights (coefficients) that modify inputs are randomly initialized.

Boltzmann machines optimize weights and quantities and are particularly well suited to represent and solve difficult combinatorial problems. To solve a learning problem, a Boltzmann machine is shown a set of binary data vectors and must find weights on the connections so that the data vectors are good solutions to the optimization problem defined by those weights.

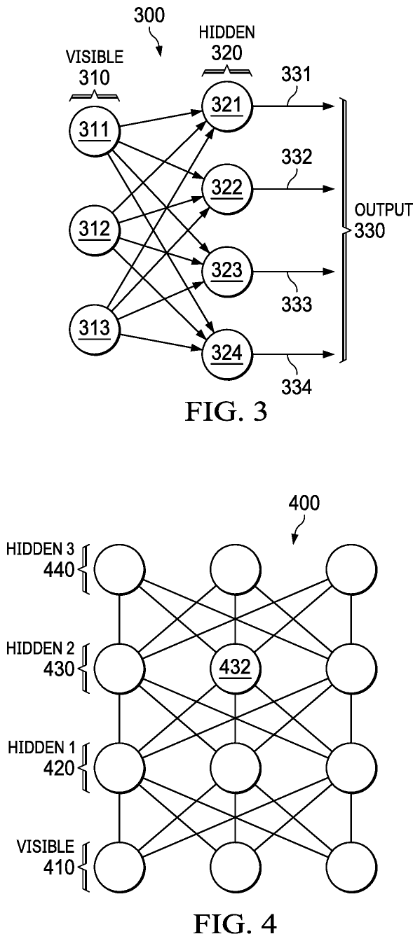

FIG. 3 is a diagram illustrating a restricted Boltzmann machine in which illustrative embodiments can be implemented. As shown in FIG. 3, the nodes in the Boltzmann machine 300 are divided into a layer of visible nodes 310 and a layer of hidden nodes 320. A common problem with general Boltzmann machines is that they stop learning correctly when they are scaled up. Restricted Boltzmann machines (RBMs) overcome this problem by using an architecture that does not allow connections between nodes in the same layer. As can be seen in FIG. 3, there is no intralayer communication between nodes.

The visible nodes 310 are those that receive information from the environment (i.e. a set of external training data). Each visible node in layer 310 takes a low-level feature from an item in the dataset and passes it to the hidden nodes in the next layer 320. When a node in the hidden layer 320 receives an input value x from a visible node in layer 310 it multiplies x by the weight assigned to that connection (edge) and adds it to a bias b. The result of these two operations is then fed into an activation function which produces the node's output.

In symmetric networks such as Boltzmann machine 300, each node in one layer is connected to every node in the next layer. For example, when node 321 receives input from all of the visible nodes 311-313 each x value from the separate nodes is multiplied by its respective weight, and all of the products are summed. The summed products are then added to the hidden layer bias, and the result is passed through the activation function to produce output 331. A similar process is repeated at hidden nodes 322-324 to produce respective outputs 332-334. In the case of a deeper neural network (discussed below), the outputs 330 of hidden layer 320 serve as inputs to the next hidden layer.

Training a Boltzmann machine occurs in two alternating phases. The first phase is the “positive” phase in which the visible nodes' states are clamped to a particular binary state vector sampled from the training set (i.e. the network observes the training data). The second phase is the “negative” phase in which none of the nodes have their state determined by external data, and the network is allowed to run freely (i.e. the network tries to reconstruct the input). In the negative reconstruction phase the activations of the hidden layer 320 act as the inputs in a backward pass to visible layer 310. The activations are multiplied by the same weights that the visible layer inputs were on the forward pass. At each visible node 311-313 the sum of those products is added to a visible-layer bias. The output of those operations is a reconstruction r (i.e. an approximation of the original input x).

On the forward pass, the RBM uses inputs to make predictions about node activations (i.e. the probability of output given a weighted input x). On the backward pass, the RBM is attempting to estimate the probability of inputs x given activations a, which are weighted with the same coefficients as those used on the forward pass. The bias of the hidden layer helps the RBM to produce activations on the forward pass. Biases impose a floor so that at least some nodes fire no matter how sparse the input data. The visible layer bias helps the RBM learn the reconstructions on the backward pass.

Because the weights of the RBM are randomly initialized the difference between the reconstructions and the original inputs is often large. That error is then backpropagated against the RBM's weights in an iterative learning process, and the weights are adjusted until an error minimum is reached.

In machine learning, a cost function estimates how the model is performing. It is a measure of how wrong the model is in terms of its ability to estimate the relationship between input x and output y. This is expressed as a difference or distance between the predicted value and the actual value. The cost function (i.e. loss or error) can be estimated by iteratively running the model to compare estimated predictions against known values of y during supervised learning. The objective of a machine learning model, therefore, is to find parameters, weights, or a structure that minimizes the cost function.

Gradient descent is an optimization algorithm that attempts to find a local or global minima of a function, thereby enabling the model to learn the gradient or direction that the model should take in order to reduce errors. As the model iterates, it gradually converges towards a minimum where further tweaks to the parameters produce little or zero changes in the loss. At this point the model has optimized the weights such that they minimize the cost function.

As mentioned above, RBMs can be stacked to created deep networks. After training one RBM, the activities of its hidden nodes can be used as training data for a higher level RBM, thereby allowing stacking of RBMs. Such stacking makes it possible to efficiently train several layers of hidden nodes. One such type of stacked network is the Deep Boltzmann machine.

FIG. 4 is a diagram illustrating a Deep Boltzmann machine in which illustrative embodiments can be implemented. A Deep Boltzmann machine (DBM) is a network of symmetrically coupled stochastic binary nodes, comprising a layer of visible nodes 410 and multiple layers of hidden nodes 420-440. Like RBMs, the Deep Boltzmann machine 400 has no connections between nodes in the same layer. It should be understood that the number of nodes and layers depicted in FIG. 4 is chosen merely for ease of illustration and that the present disclosure can be implemented using more or less nodes and layers that those shown.

DBMs learn the hierarchical structure of features, wherein each subsequent layer in the DBM processes more complex features than the layer below it. For example, in FIG. 4, the first hidden layer 420 might process low-level features, such as, e.g., the edges of an image. The next hidden layer up 430 would process higher-level features, e.g., combinations of edges, and so on. This process continues up the layers, learning simpler representations and then composing more complex ones.

The DBM is created by first separately pre-training each RBM in a stack and then combining them to form a single DBM. A key characteristic of DBMs is that all of the connections between the layers are undirected, as depicted in FIG. 4, meaning signals can travel in both directions between nodes and layers. This undirected architecture allows the DBM 400 to apply inference and learning procedures using both bottom-up and top-down passes, thereby producing dependencies between hidden variables in both directions, not just from the layers below. For example, in FIG. 4, the state of hidden variable 432 is dependent on the states of the hidden variables in both layers 420 and 440. This allows the DBM to handle uncertainty more effectively than other deep networks that rely solely on bottom-up, feed forward learning.

In bottom-up sequential learning, the weights are adjusted at each new hidden layer until that layer is able to approximate the input from the previous lower layer. In contrast, the undirected architecture of DBMs allows the joint optimization of all levels, rather than sequentially up the layers of the stack.

DBMs perform well in many application domains. They are capable of fast inference in a fraction of a second, and learning can scale to millions of examples.

In determining the optimum farming portfolio multiple parameter are taken into account with particular emphasis on weather, season (e.g., monsoon vs. spring, or winter vs. summer), uncontrollable external factors (e.g., natural calamities, storms, and earthquakes), and sensitivity of crops to pests and pesticides. Most other factors that are already known are secondary in importance such as cost per square foot, crops relevant to season, land, local climate, soil characteristics, aqua prone (some plants need more water that others), and geographic factors such as geo-spatial location, desert, proximity to ocean, etc.

Growing seasons will vary between different geographic regions. For example, South Asia has a monsoon season that lasts between April and October. Examples of domesticated plants cultivated and harvested during that timeframe include rice, millet, corn, green gram, and black gram. Examples of spring crops that are planted around mid-November, after monsoon season, and harvested in April and May include cereal grains like wheat, oats, barley, and maize. In North American grains such as winter wheat is typically planted in September to October and harvested in later August to October, while crops like hard red spring wheat and durum wheat are planted in April to May and harvested mid-July to mid-September.

Current analytical models can predict the crops in a particular region at a given time that will produce the maximum profit based on soil conditions, water level, rainfall, etc. However, the user might have other constraints that have to be factored into the predictive model. For example, a user wants to know which crops will yield maximum profit but can only farm between January and June. Such cases are complex to handle. Within a six month timeframe there can be multiple seasons, floods and drought, and there are crops which can withstand both flood and drought as well as seasonal crops. Hence the user has to have a balance portfolio of crops. This can be modeled in cascaded Boltzmann machines.

In the present disclosure, a DBM is constructed based on different factors affecting the onset of a season, with random weights being assigned to the factors. The inputs are clustered based on relevance. For example, if X₁ indicates greenhouse gas emission rate and X₂ indicates rate of increase in temperature, based on the training set both factors can be different features or can regularized to a single feature to avoid overfitting, i.e. X₁²X₂³. The output comprises multiple classes, each indicating the probability of onset of a season. For example, a threshold can be set as 0.5 and Output 1 is the probability of summer season, with the associated output features such as rainfall percentage, humidity percentage, etc.

With the initial weights and thresholds set, the Boltzmann machine of the present disclosure is trained with forward propagation with vectorized implementation. With no bias values, each layer learns based on its inputs to obtain the hypothesis function The cost function of the Boltzmann machine is obtained as below:

$${J}_{l} ( θ ) = 1 / m [ {\sum }_{i = 1}^{m} {y}^{i} log {h}_{θ ( {x}^{i} )} + ( 1 - {y}^{i} ) log ( 1 - {h}_{θ} {x}^{i} ) ] + ( λ / 2 m ) {\sum }_{j = 1}^{n} {θ}_{j}^{2}$$

where xⁱ represents the input features

$$x = [ \begin{matrix}Temperature \\ Humidity \\ GreenHouseGasDensity \\ Timeframe \\ …\end{matrix} ]$$

h_{θ(x}_{ⁱ}₎ is the hypothesis function parameterized by weights θ

$${h}_{θ} = [ \begin{matrix}Season 1 \\ Season 2 \\ Season 3 \\ …\end{matrix} ]$$

The value of the hypothesis function is compared with a predefined threshold to select the predicted output classes. For example, if the threshold is 0.5 and the Season1 Output unit has a probability of 0.6, and all other output units are less than 0.5, then Output Unit1 is taken as the next stage of the cascaded Boltzmann machines. If there are more than one output units crossing the threshold, then all are carried forward to the next step. For example, the deep learning might predict the season will be summer or rainy with equal probability during the timeframe selected.

In the vectorized implementation, the hypothesis function h_{θ(s}_{ⁱ}₎ is a k-dimension vector, and accordingly the cost function changes. The partial derivative of the cost function is obtained to minimize the error and to arrive at the correct weights at each layer using backward propagation.

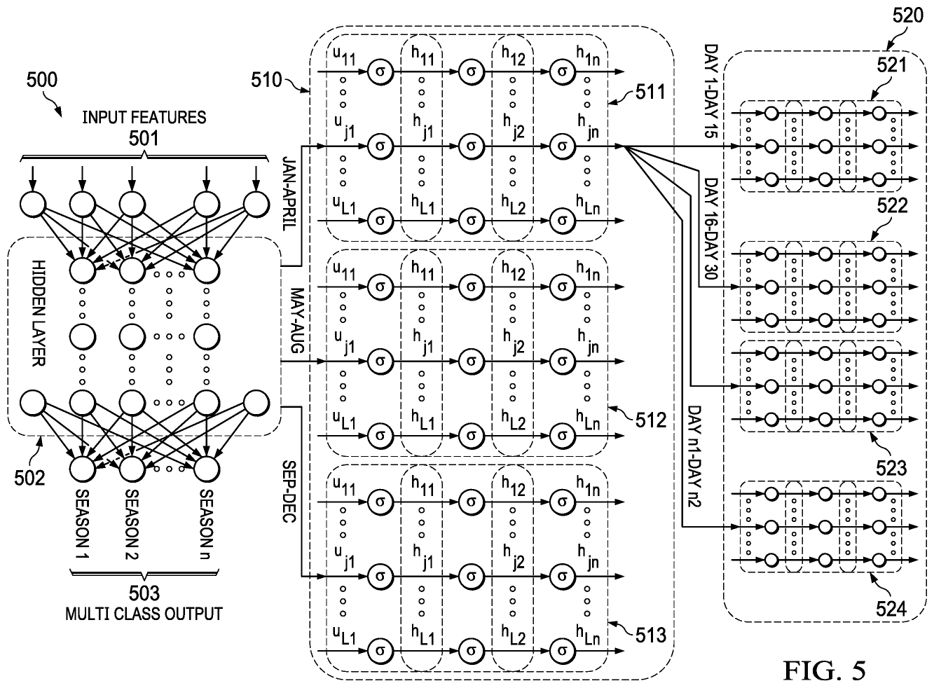

FIG. 5 depicts a cascaded Deep Boltzmann machine in which illustrative embodiments can be implemented. The Deep Boltzmann machine (DBM) 500 receives input features 501, which are fed through the hidden layer 502 to produce a multi-class output 503 representing different growing seasons. As an example implementation of the present disclosure, a farmer might not have a lengthy timeframe in which to plant and harvest crops and is therefore presented with a short and limited boundary in which to optimize the farming portfolio. Accurate results can be obtained by splitting the hidden layer 502 into multiple deep neural networks for each segregated unit of time.

In the example shown in FIG. 5, the hidden layer 502 of DBM 500 is split into separate cascaded stages or layers 510, 520 of neural networks, with each stage dedicated to modelling a different scale of time. In the example shown layer 510 models thirds of the year, which each neural network 511-513 modeling a different four-month segment of the year (i.e. January-April, May-August, September-December). As an alternative example, layer 510 might be dedicated to yearly quarters.

Each neural network 511-513 within layer 510 in turn is split into a plurality of neural networks, each modeling a different sub-timeframe of the parent neural network. In the present example, each four-month timeframe 511-513 is further divided into 15-day segments 521-524, each with its own neural network in layer 520. For ease of illustration only the cascaded neural networks 521-524 of network 511 are shown in layer 520. Each of the 15-day segments can in turn be split into smaller timeframes and so on. Each level of granularity (timescale unit) in the timeframe is optimized by a separate layer of networks.

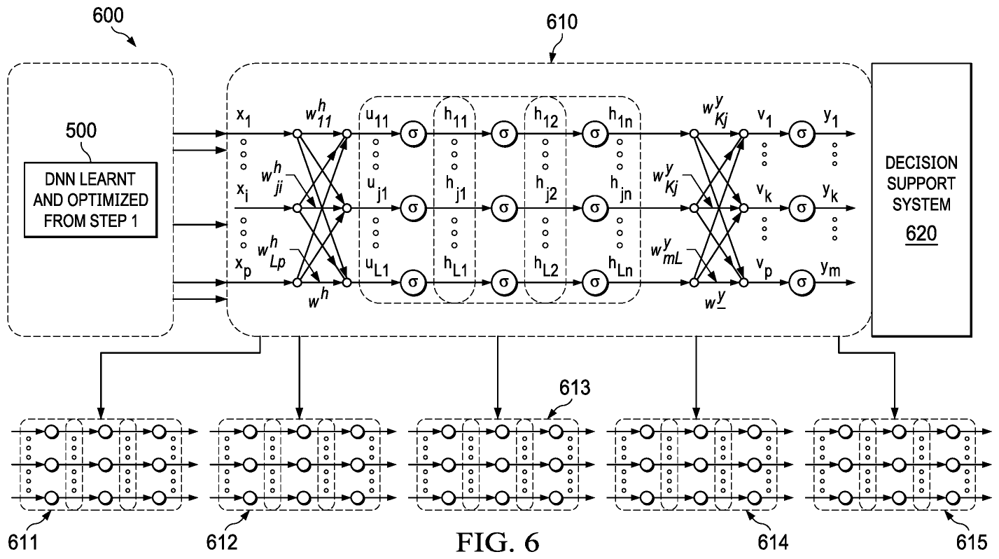

FIG. 6 depicts a second Deep Boltzmann machine in which illustrative embodiments can be implemented. The output classes of DBM 500 are fed into DBM 600 as input units, along with other input features that are likely to impact crop yield, to maximize profit. The output from DBM 600 is fed into a Decision Support System (DSS) 620 to assist the farmer in creating the farming portfolio.

Similar to the cascaded DBM 500 in FIG. 5, the hidden layer 610 in DBM 600 in FIG. 6 can also be split into multiple networks 611-615 to model each timeframe to arrive at an accurate prediction for the user's constraints. The cascaded DBM 600 follows similar steps as those defined above regarding DBM 500 using forward and backward propagation.

If one considers a single-layer model covering one year, the final output would be a crop predicted for that year that would produce maximum yield. However, the cascaded models described above will produce multiple classes (timeframes) of outputs with crop predictions for each class, e.g., crop 1 for month 1, crop 2 for month 2, etc.

The probabilistic function of the output classes is

p(h_{θ}^{l})=(1/Z(θ))exp(−E(H_{θ}))

where E is the energy function and Z is the normalizing constant. The energy function E is a function of the number of nodes in the visible and hidden layers and the corresponding weights.

One can consider the prediction based on a single-layered model for the whole year as

y¹=[Crop5]

This indicates that Crop5 would give the maximum yield considering all of the seasons of the year and other impacting parameters.

A prediction based on two cascaded models, with each model covering six months might be expressed as

$${y}^{2} = [ \begin{matrix}Crop 1 \\ Crop 2\end{matrix} ]$$

This indicates that planting Crop1 in the first half of the year and Crop2 in the second half would produce maximum yield.

A prediction based on six cascaded models, each model covering two months, might be expressed as

$${y}^{3} = [ \begin{matrix}Crop 1 \\ Crop 1 \\ Crop 3 \\ Crop 4 \\ Crop 4 \\ Crop 4\end{matrix} ]$$

In this example, the result indicates planting Crop1 for the first four months followed by Crop3 for the next two months, and then Crop4 for the last six months would produce the maximum overall yield for the year.

The corresponding hypothesis functions would give the predicted profit in each example described above.

The multi-class output units are fed into the Decision Support System (DSS), which takes the intelligent decision by considering all of the output predictions and the profits based on the hypothesis functions. The DSS performs consolidated analysis of the multi-class outputs from each of the modalities individualized for the user and provides the recommendation based on optimal time duration to reduce the risk and maximize yield. As an example, the DSS might give the following output for a one-year period

$${DSS}_{12 months} = [ \begin{matrix}Crop 1 \\ Crop 1 \\ Crop 1 \\ Crop 1 \\ Crop 4 \\ Crop 4 \\ Crop 4 \\ Crop 4 \\ Crop 4 \\ Crop 4 \\ Crop 4 \\ NULL\end{matrix} ]$$

This result indicates that Crop1 for the first four months, Crop4 for the next seven months, and no farming during the last month of the year would produce the maximum overall profit.

Returning to the example of a farmer working within a six-month constraint, the DSS might produce an output such as

$${DSS}_{6 months} = [ \begin{matrix}Crop 1 \\ Crop 1 \\ Crop 1 \\ Crop 1 \\ Crop 2 \\ Crop 2\end{matrix} ]$$

In this example, the DSS output indicates that for a six month timeframe Crop1 should be grown for the first four months, followed by Crop2 for the last two months to produce maximum yield. The constraints for each crop are also taken into consideration. Therefore, Crop1 would be planted, grown, and harvested in fourth months. Hence, the neural models would predict planting Crop1 for the duration in the multiple of four shown in the result above.

The analytical model of the DSS identifies an optimum allocation of the farm land for planting different crops during different parts of the available timeframe to maximize total yield and profit for the available timeframe.

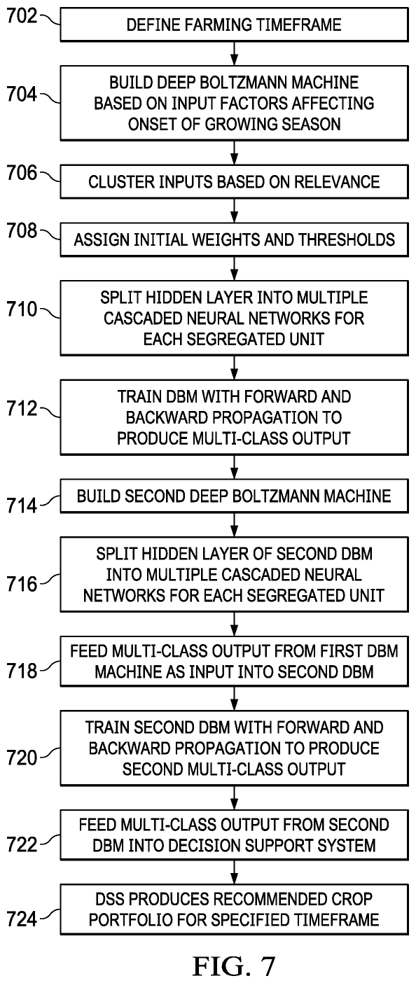

FIG. 7 is a flowchart illustrating a process flow of optimizing allocation of agricultural resources in which illustrative embodiments can be implemented. The process begins by defining the farming timeframe for which the farming portfolio is to be optimized (step 702). As explained above, this timeframe might be a year, a six-month period, or some other suitable timeframe chosen according to the operating constraints of the user.

The initial Deep Boltzmann machine is built based on the input factors that affect the onset of the growing season for a plurality of potential crops (step 704). These factors include, e.g., temperature, humidity, green house gas density, timeframe, etc. The inputs are clustered based on relevance, which can include combining them depending on their degree of correlation (step 706). The initial random weights are assigned to the model factors and thresholds are assigned to the outputs (step 706).

The hidden layer of the DBM is then split into multiple cascaded neural networks to model each segregated unit (step 710). These segregated units comprise different sub-timeframes within the timeframe defined in step 702 (e.g., seasons, years, quarters, months, weeks, days, etc.), with each level of timeframe unit having its own set of respective neural networks as described above. The neural networks can be progressively subdivided into a specified number of additional layers of neural networks, wherein layer of neural network models crop growth for a smaller segment of time.

The DBM is then trained using the cascaded neural networks to minimize the cost function and produce a multi-class output comprising predicted crops that will produce the maximum yield for the different timeframes modeled by the cascaded neural networks (step 712).

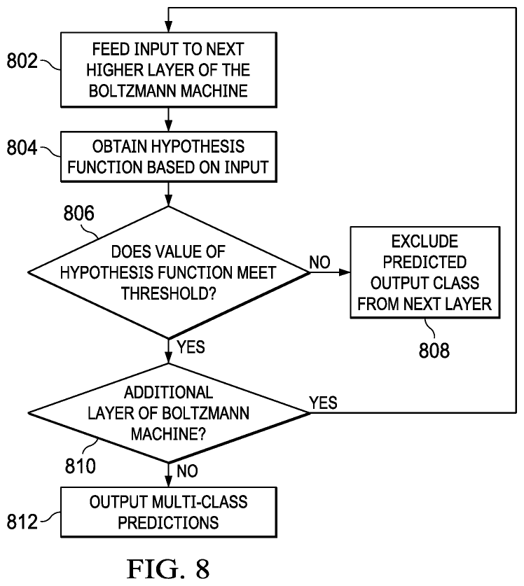

FIG. 8 is a flowchart illustrating a process flow for training a cascaded Deep Boltzmann machine in which illustrative embodiments can be implemented. The process begins by feeding input into the next higher stage or layer of the Boltzmann machine (step 802). In the case of the initial input from the visible layer of the DBM, the input is fed into the lowest layer of the cascade modeling the smallest selected timeframes. Using the example shown in FIG. 5, the input would first be fed into the neural networks in layer 520.

The layer uses its inputs to obtain the hypothesis function (step 804). The value of the hypothesis function from each neural network in the layer is compared with a predefined threshold to select the predicted output classes (step 806). If the value of a predicted output class does not meet the threshold it is excluded from being fed into the next layer of the Boltzmann machine (step 808).

If the value of the hypothesis function does meet the threshold the DBM determines if there is an additional cascaded layer of the Boltzmann machine remaining within the hidden layer (step 810). If there is another cascaded layer, the selected output classes from the previous layer are fed into the next higher layer (back to step 802). If there are no more higher layers remaining, the selected predictions are output as the multi-class output of the DBM (step 812).

Returning to FIG. 7, a second DBM is also built (step 714), and its hidden layer is split into multiple cascaded neural networks for each segregated unit (step 716), similar to the manner in which the first DBM is built. As in step 710, the neural networks can be progressively subdivided into a specified number of additional layers of neural networks, wherein layer of neural network models crop growth for a smaller segment of time.

The multi-class output of the first DBM is fed into the second DBM as its input (step 718), and the second DBM is trained with forward and backward propagation through the cascaded neural networks to minimize the cost function and produce a second multi-class output of predicted crops producing maximum yields within the respective timeframes and sub-timeframes (step 720). This process is similar to that described above regarding FIG. 8.

The multi-class output from the second DBM is then fed into the Decision Support System (step 722), and the DSS produces the recommended farming portfolio for the specified timeframe as described above (step 724).

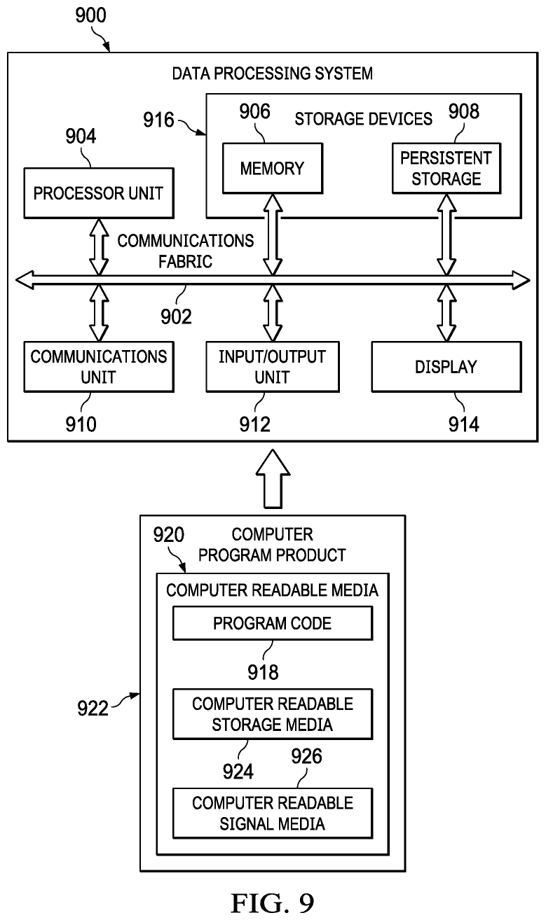

Turning to FIG. 9, a diagram of a data processing system is depicted in accordance with an illustrative embodiment. Data processing system 900 is an example of a system in which computer-readable program code or program instructions implementing processes of illustrative embodiments may be run. Data processing system 900 may be an example of one system in which root cause analysis system 116 in FIG. 1 may be implemented. In this illustrative example, data processing system 900 includes communications fabric 902, which provides communications between processor unit 904, memory 906, persistent storage 908, communications unit 910, input/output unit 912, and display 914.

Processor unit 904 serves to execute instructions for software applications and programs that may be loaded into memory 906. Processor unit 904 may be a set of one or more hardware processor devices or may be a multi-processor core, depending on the particular implementation. Further, processor unit 904 may be implemented using one or more heterogeneous processor systems, in which a main processor is present with secondary processors on a single chip. As another illustrative example, processor unit 904 may be a symmetric multi-processor system containing multiple processors of the same type.

A computer-readable storage device is any piece of hardware that is capable of storing information, such as, for example, without limitation, data, computer-readable program code in functional form, and/or other suitable information either on a transient basis and/or a persistent basis. Further, a computer-readable storage device excludes a propagation medium. Memory 906, in these examples, may be, for example, a random access memory, or any other suitable volatile or non-volatile storage device. Persistent storage 908 may take various forms, depending on the particular implementation. For example, persistent storage 908 may contain one or more devices. For example, persistent storage 908 may be a hard drive, a flash memory, a rewritable optical disk, a rewritable magnetic tape, or some combination of the above. The media used by persistent storage 908 may be removable. For example, a removable hard drive may be used for persistent storage 908.

Communications unit 910, in this example, provides for communication with other computers, data processing systems, and devices via network communications unit 910 may provide communications using both physical and wireless communications links. The physical communications link may utilize, for example, a wire, cable, universal serial bus, or any other physical technology to establish a physical communications link for data processing system 900. The wireless communications link may utilize, for example, shortwave, high frequency, ultra-high frequency, microwave, wireless fidelity (WiFi), Bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 900.

Input/output unit 912 allows for the input and output of data with other devices that may be connected to data processing system 900. For example, input/output unit 912 may provide a connection for user input through a keypad, keyboard, and/or some other suitable input device. Display 914 provides a mechanism to display information to a user and may include touch screen capabilities to allow the user to make on-screen selections through user interfaces or input data, for example.

Instructions for the operating system, applications, and/or programs may be located in storage devices 916, which are in communication with processor unit 904 through communications fabric 902. In this illustrative example, the instructions are in a functional form on persistent storage 908. These instructions may be loaded into memory 906 for running by processor unit 904. The processes of the different embodiments may be performed by processor unit 904 using computer-implemented program instructions, which may be located in a memory, such as memory 906. These program instructions are referred to as program code, computer-usable program code, or computer-readable program code that may be read and run by a processor in processor unit 904. The program code, in the different embodiments, may be embodied on different physical computer-readable storage devices, such as memory 906 or persistent storage 908.

Program code 918 is located in a functional form on computer-readable media 920 that is selectively removable and may be loaded onto or transferred to data processing system 900 for running by processor unit 904. Program code 918 and computer-readable media 920 form computer program product 922. In one example, computer-readable media 920 may be computer-readable storage media 924 or computer-readable signal media 926. Computer-readable storage media 924 may include, for example, an optical or magnetic disc that is inserted or placed into a drive or other device that is part of persistent storage 908 for transfer onto a storage device, such as a hard drive, that is part of persistent storage 908. Computer-readable storage media 924 also may take the form of a persistent storage, such as a hard drive, a thumb drive, or a flash memory that is connected to data processing system 900. In some instances, computer-readable storage media 924 may not be removable from data processing system 900.

Alternatively, program code 918 may be transferred to data processing system 800 using computer-readable signal media 926. Computer-readable signal media 926 may be, for example, a propagated data signal containing program code 918. For example, computer-readable signal media 926 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer-readable media also may take the form of non-tangible media, such as communication links or wireless transmissions containing the program code.

In some illustrative embodiments, program code 918 may be downloaded over a network to persistent storage 908 from another device or data processing system through computer-readable signal media 926 for use within data processing system 900. For instance, program code stored in a computer-readable storage media in a data processing system may be downloaded over a network from the data processing system to data processing system 900. The data processing system providing program code 918 may be a server computer, a client computer, or some other device capable of storing and transmitting program code 918.

The different components illustrated for data processing system 900 are not meant to provide architectural limitations to the manner in which different embodiments may be implemented. The different illustrative embodiments may be implemented in a data processing system including components in addition to, or in place of, those illustrated for data processing system 900. Other components shown in FIG. 9 can be varied from the illustrative examples shown. The different embodiments may be implemented using any hardware device or system capable of executing program code. As one example, data processing system 900 may include organic components integrated with inorganic components and/or may be comprised entirely of organic components excluding a human being. For example, a storage device may be comprised of an organic semiconductor.

As another example, a computer-readable storage device in data processing system 900 is any hardware apparatus that may store data. Memory 906, persistent storage 908, and computer-readable storage media 924 are examples of physical storage devices in a tangible form.

In another example, a bus system may be used to implement communications fabric 802 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 906 or a cache such as found in an interface and memory controller hub that may be present in communications fabric 802.

The present invention may be a system, a method, and/or a computer program product. The computer program product may include a computer-readable storage medium or media having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer readable program instructions to personalize the electronic circuitry, in order to perform aspects of the present invention.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, illustrative embodiments of the present invention provide a computer-implemented method, computer system, and computer program product for managing idempotent operations by an idempotency resolver service using a mapping table while interacting with a system of record to increase response time and decrease recovery time. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing the allocation of farmland between different crops, the computer-implemented method comprising:
defining an overall timeframe for farming a predetermined area of land;
building a first Deep Boltzmann machine (DBM), wherein a hidden layer of the first DBM is split into a first plurality of neural networks, wherein each neural network models a separate sub-timeframe with the overall timeframe;
inputting into the first DBM a plurality of factors related to crop growth for a plurality of crops;
training the first DBM to produce a first multi-class output of predicted maximum crop yields within the overall timeframe;
building a second DBM, wherein a hidden layer of the second DBM is split into a second plurality of neural networks, wherein each neural network models a separate sub-timeframe with the overall timeframe;
inputting the first multi-class output into the second DBM;
training the second DBM to produce a second multi-class output of predicted maximum crop yields within the overall timeframe; and
feeding the second multi-class output into a decision support system (DSS), wherein the DSS generates a recommended allocation of the predetermined area of land among different crops during different sub-timeframes to maximize total yield for the overall timeframe.

2. The method of claim 1, wherein the first and second multi-class outputs further comprise a prediction of which crop will produce a maximum yield for each sub-timeframe.

3. The method of claim 1, wherein each class of the multi-class outputs indicates a probability of onset of a growing season.

4. The method of claim 1, wherein each neural network within the first and second pluralities of neural networks is progressively subdivided into a specified number of additional layers of neural networks, wherein each layer of neural networks models predicted crop growth for a smaller segment of time.

5. The method of claim 4, wherein only predicted values from each layer of neural networks that meet a predefined threshold are fed into the next higher layer of neural networks.

6. The method of claim 1, wherein the factors input into the first DBM are clustered together based on relevance.

7. The method of claim 1, wherein the factors input into the first DBM comprises at least one of:
temperature;
humidity;
greenhouse gas density;
season of the year;
sensitivity of crops to pests and pesticides;
weather patterns; and
likelihood of natural disasters.

8. A computer system for optimizing the allocation of farmland between different crops, the computer system comprising:
a bus system;
a storage device connected to the bus system, wherein the storage device stores program instructions; and
a processor connected to the bus system, wherein the processor executes the program instructions to:
define an overall timeframe for farming a predetermined area of land;
build a first Deep Boltzmann machine (DBM), wherein a hidden layer of the first DBM is split into a first plurality of neural networks, wherein each neural network models a separate sub-timeframe with the overall timeframe;
input into the first DBM a plurality of factors related to crop growth for a plurality of crops;
train the first DBM to produce a first multi-class output of predicted maximum crop yields within the overall timeframe;
build a second DBM, wherein a hidden layer of the second DBM is split into a second plurality of neural networks, wherein each neural network models a separate sub-timeframe with the overall timeframe;
input the first multi-class output into the second DBM;
train the second DBM to produce a second multi-class output of predicted maximum crop yields within the overall timeframe; and
feed the second multi-class output into a decision support system (DSS), wherein the DSS generates a recommended allocation of the predetermined area of land among different crops during different sub-timeframes to maximize total yield for the overall timeframe.

9. The computer system according to claim 8, wherein the first and second multi-class outputs further comprise a prediction of which crop will produce a maximum yield for each sub-timeframe.

10. The computer system according to claim 8, wherein each class of the multi-class outputs indicates a probability of onset of a growing season.

11. The computer system according to claim 8, wherein each neural network within the first and second pluralities of neural networks is progressively subdivided into a specified number of additional layers of neural networks, wherein each layer of neural networks models predicted crop growth for a smaller segment of time.

12. The computer system according to claim 11, wherein only predicted values from each layer of neural networks that meet a predefined threshold are fed into the next higher layer of neural networks.

13. The computer system according to claim 8, wherein the factors input into the first DBM are clustered together based on relevance.

14. A computer program product for optimizing the allocation of farmland between different crops, the computer program product comprising a non-volatile computer readable storage medium having program instructions embodied therewith, the program instructions executable by a computer to cause the computer to perform a method comprising:
defining an overall timeframe for farming a predetermined area of land;
building a first Deep Boltzmann machine (DBM), wherein a hidden layer of the first DBM is split into a first plurality of neural networks, wherein each neural network models a separate sub-timeframe with the overall timeframe;
inputting into the first DBM a plurality of factors related to crop growth for a plurality of crops;
training the first DBM to produce a first multi-class output of predicted maximum crop yields within the overall timeframe;
building a second DBM, wherein a hidden layer of the second DBM is split into a second plurality of neural networks, wherein each neural network models a separate sub-timeframe with the overall timeframe;
inputting the first multi-class output into the second DBM;
training the second DBM to produce a second multi-class output of predicted maximum crop yields within the overall timeframe; and
feeding the second multi-class output into a decision support system (DSS), wherein the DSS generates a recommended allocation of the predetermined area of land among different crops during different sub-timeframes to maximize total yield for the overall timeframe.

15. The computer program product according to claim 14, wherein the first and second multi-class outputs further comprise a prediction of which crop will produce a maximum yield for each sub-timeframe.

16. The computer program product according to claim 14, wherein each class of the multi-class outputs indicates a probability of onset of a growing season.

17. The computer program product according to claim 14, wherein each neural network within the first and second pluralities of neural networks is progressively subdivided into a specified number of additional layers of neural networks, wherein each layer of neural networks models predicted crop growth for a smaller segment of time.

18. The computer program product according to claim 17, wherein only predicted values from each layer of neural networks that meet a predefined threshold are fed into the next higher layer of neural networks.

19. The computer program product according to claim 14, wherein the factors input into the first DBM are clustered together based on relevance.

20. The computer program product according to claim 14, wherein the factors input into the first DBM comprises at least one of:
temperature;
humidity;
greenhouse gas density;
season of the year;
sensitivity of crops to pests and pesticides;
weather patterns; and
likelihood of natural disasters.
